(19) United States
(12) Patent Application Publication
(10) Pub. No.: US 2013/0265224 A1
(43) Pub. Date: Oct. 10, 2013

(54) DISPLAY SYSTEM, DISPLAY DEVICE, DISPLAY CONTROL METHOD, AND PHARMACEUTICAL MANAGEMENT SYSTEM

(71) Applicant: PANASONIC CORPORATION, Osaka (JP)

(72) Inventors: Keigo FUJITA, Osaka (JP); Masaki YAMAMOTO, Ehime (JP); Takumi NISHIMURA, Saitama (JP)

(21) Appl. No.: 13/910,457

(22) Filed: Jun. 5, 2013

Related U.S. Application Data
(63) Continuation-in-part of application No. PCT/JP2011/007222, filed on Dec. 22, 2011.

(30) Foreign Application Priority Data
Dec. 24, 2010 (JP) 2010-287303

(51) Int. Cl. G06F 21/60

(52) U.S. Cl. CPC G06F 21/60
USPC 345/156

(57) ABSTRACT

In a display system, a remote control has a first signal production component for producing a first image switching signal, which is a command signal to switch between first image data, which includes confidential information and second image data, which is non-confidential information, in response to a manipulation component being manipulated by a specific user. A display device has a first image switching component that directs switching between the first image data and the second image data displayed on the display device, according to the first image switching signal received from the remote control. When the first image switching signal is inputted, the first image switching component executes first image switching control in which the first image data displayed on the display device is switched to the second image data and the second image data displayed on the display device is switched to the first image data.

### PRIORITY

This is a continuation-in-part under 35 U.S.C. §120 and 35 U.S.C. §365 of International Application PCT/JP2011/007222, with an international filing date of Dec. 22, 2011 which claims priority to Japanese Patent Application No. 2010-287303 filed on Dec. 24, 2010. The entire disclosures of International Application PCT/JP2011/007222 and Japanese Patent Application No. 2010-287303 are hereby incorporated herein by reference.

### TECHNICAL FIELD

The present invention relates to display control of a display device attached to an object conveyor in the conveyance of objects in a hospital or other facility.

### BACKGROUND ART

Pharmaceutical management systems that manage pharmaceuticals have been increasingly introduced in, for example, hospitals in recent years. With such a pharmaceutical management system, when pharmaceuticals are dispensed for each patient, the pharmaceuticals are automatically selected on the basis of the prescription data for each patient, and a pharmaceutical dispensing apparatus is used to dispense the pharmaceuticals into a tray for each patient.

A rewritable card is provided to the tray into which the pharmaceuticals for each patient are dispensed by this pharmaceutical dispensing apparatus. Information related to the pharmaceuticals and patient identification information is recorded to and displayed on the rewritable cards, as disclosed in Japanese Laid-Open Patent Application 2010-069000, for example.

In general, a tray into which a pharmaceutical has been dispensed by a pharmaceutical dispensing apparatus installed in the pharmaceutical department of a hospital is moved from the pharmaceutical department to the nurses' station. After this, the tray is conveyed to where the patient is (such as a hospital room). The rewritable card that is attached to the tray must display confidential information about the hospital, including personal information about the patient. However, a conventional rewritable card displayed such confidential information at all times during the movement of the tray (particularly during movement from the hospital's pharmaceutical department to the nurses' station). Therefore, there was the possibility that such confidential information would be divulged to outsiders.

### SUMMARY

In view of this, the technology disclosed hereinafter aims to prevent confidential information, including personal information, from being divulged to outsiders.

According to one aspect of the technology disclosed herein, there is provide a display system comprising a display device and a remote control. The display device is configured to hold first image data and second image data and configured to display the first image data or the second image data. The first image data includes confidential information, and the second image is non-confidential information. The remote control includes a manipulation component configured to produce signals and send the signals to the display device. The remote control further includes a first signal production component and a transmitter. The first signal production component is configured to produce a first image switching signal in response to the manipulation component being manipulated by a user. The first image switching signal is a command signal to switch between the first image data and the second image data. The transmitter is configured to transmit the first image switching signal to the display device. The display device includes a receiver, a first image switching component, and a display component. The receiver is configured to receive the first image switching signal from the remote control. The first image switching component is configured to direct switching between the first image data and the second image data according to the first image switching signal. The display component is configured to display the first image data or the second image data according to a command from the first image switching component. The first image switching component is further configured to execute first image switching control when the first image switching signal is inputted. The first image switching control includes switching the first image data displayed on the display component to the second image data and switching the second image data displayed on the display component to the first image data.

With the technology above, confidential information including personal information can be prevented from being divulged to outsiders.

### BRIEF DESCRIPTION OF DRAWINGS

FIG. 1 is a simplified diagram of the configuration of a pharmaceutical management system in Embodiment 1;

FIG. 2A is a front view of a display device in Embodiment 1;

FIG. 2B is a side view of the display device;

FIG. 3A is a front view of a remote control in Embodiment 1;

FIG. 3B is a side view of the remote control;

FIG. 4 is a function block diagram of the display system in Embodiment 1;

FIG. 5 shows the image data recording state of a memory in the display device in Embodiment 1;

FIG. 6 shows examples of the first image data and second image data displayed by the display device in Embodiment 1;

FIG. 7 is a block diagram of the operation of displaying first image data and the operation of writing first image data in Embodiment 1;

FIG. 8 is a block diagram of second image switching control in Embodiment 1;

FIG. 9 is a transition diagram of image display by the display device when the above-mentioned second image switching control is performed;

FIG. 10 is a block diagram of first image switching control in Embodiment 1;

FIG. 11 is a transition diagram of image display by the display device when the above-mentioned first image switching control is performed;

FIG. 12 is a diagram illustrating remote control operation when image switching control is performed in Embodiment 1;

FIG. 13 is a flowchart showing the flow of processing by the remote control in Embodiment 1;

FIG. 14 is a flowchart showing the flow of processing by the data writing unit in Embodiment 1;

FIG. 15A is a flowchart showing the flow of processing by the display device in Embodiment 1;

FIG. 15B is a flowchart showing the flow of processing by the display device in Embodiment 1; and

FIG. 16 is a flowchart showing the flow of processing by the display device in another embodiment.

### DETAILED DESCRIPTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

An embodiment of the present invention will be described in detail through reference to the drawings.

### 1. Embodiment 1

### 1.1 Pharmaceutical Management System 1

### 1.1.1 Configuration of Pharmaceutical Management System 1

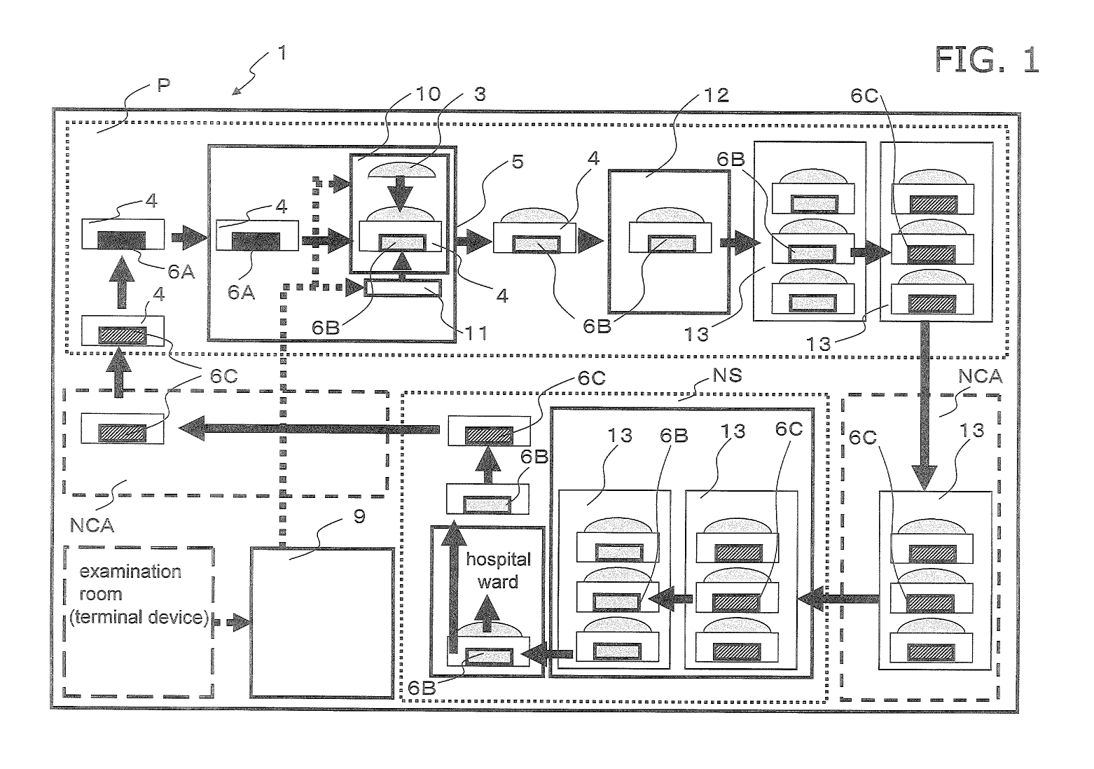

The pharmaceutical management system 1 pertaining to Embodiment 1 will be described through reference to FIG. 1. FIG. 1 is a simplified diagram of the configuration of the pharmaceutical management system 1. The pharmaceutical management system 1 is mainly used in hospital.

The pharmaceutical management system 1 includes a display system 2 (discussed below) and a plurality of trays 4 (an example of a conveyance container) into which pharmaceuticals 3 are dispensed by a pharmaceutical dispensing apparatus 5.

The pharmaceutical dispensing apparatus 5 is installed in the pharmaceutical department P of a hospital, for example. The pharmaceutical dispensing apparatus 5 dispenses the pharmaceuticals 3 for each patient on the basis of prescription data for each patient, and these pharmaceuticals 3 are automatically selected and dispensed into the tray 4 assigned to each patient.

As discussed below, the display system 2 comprises a display device 6 and a remote control 17.

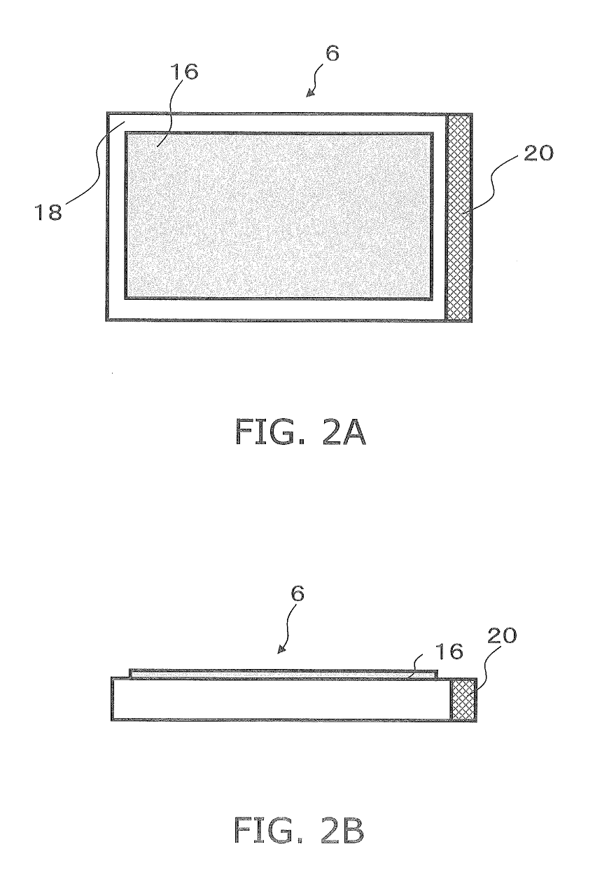

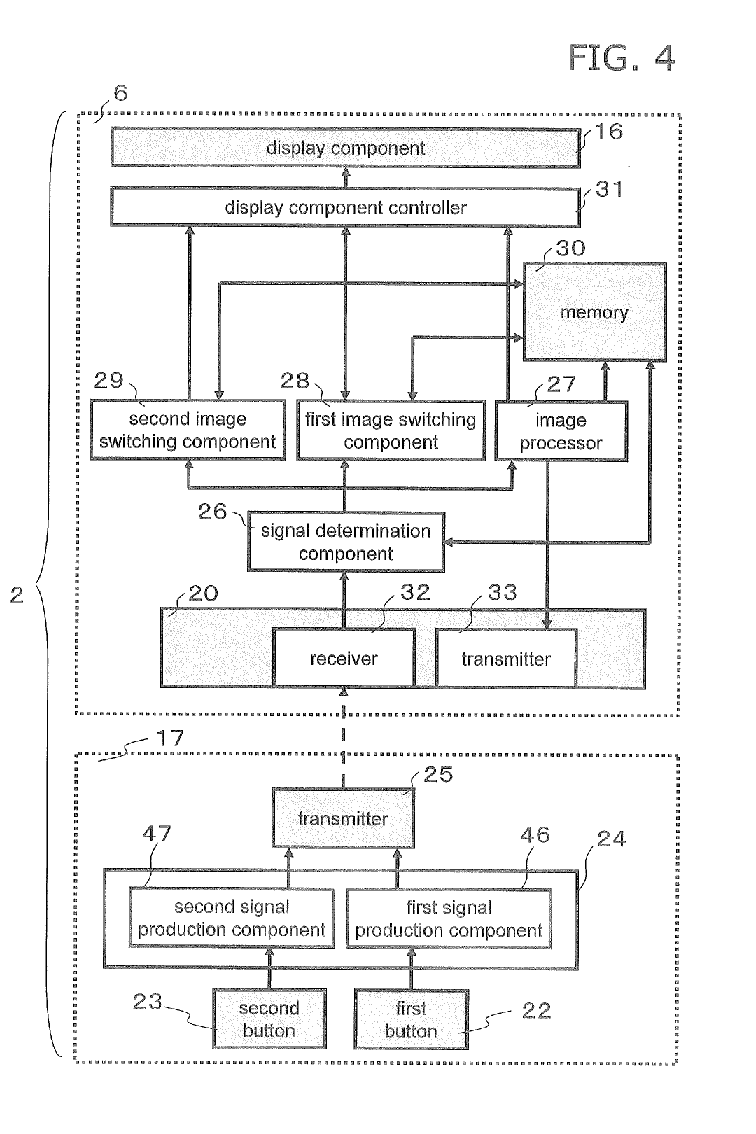

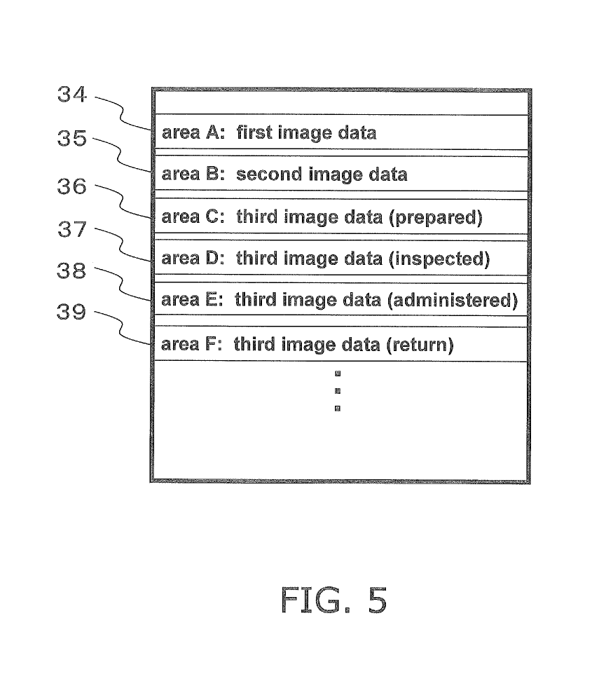

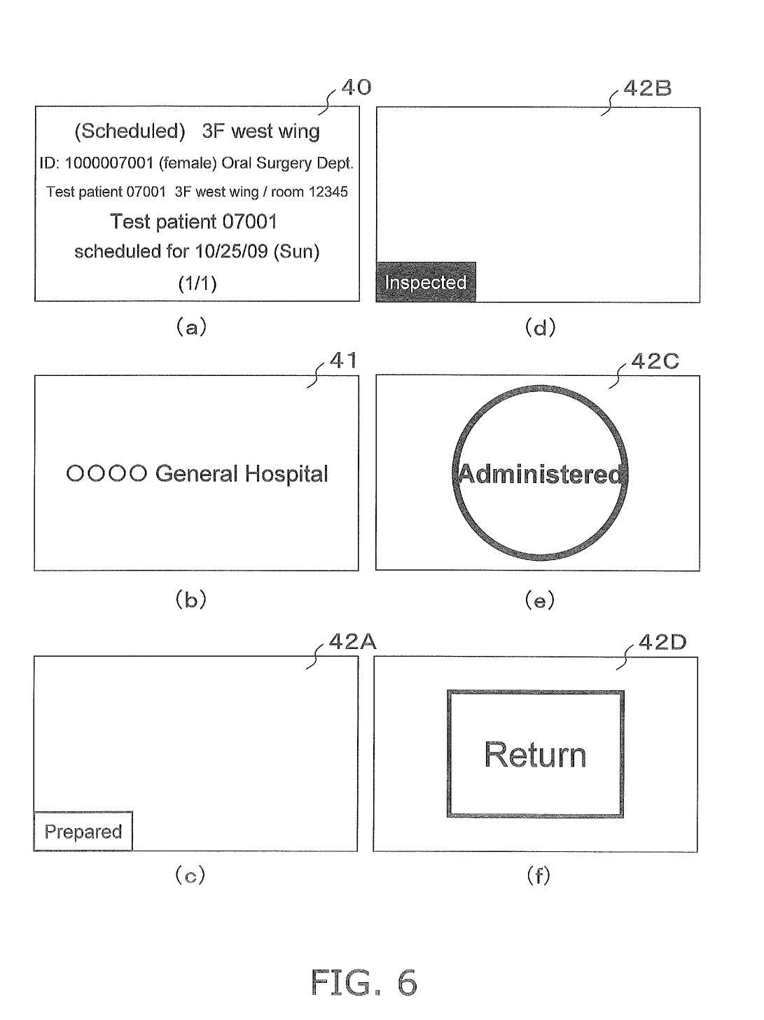

The display device 6 is attached to each of the trays 4 of the pharmaceutical dispensing apparatus 5 such that what is displayed is visible from the outside. The display device 6 displays personal information, such as the patient's name and sex, the hospital ward name, the hospital room, the date, ID, the number of trays, in order to identify which patient the dispensed pharmaceuticals 3 are for. The display device 6 also has a display component 16 (shown in FIG. 2). The display component 16 displays, for example, first image data 40 including confidential information, such as the patient's name and sex, the hospital ward and room, the date, ID, and other such personal information. This first image data 40 (such as the image data shown in FIG. 6a) includes information that needs to be kept secret from outsiders, as confidential hospital information. The display device 6 in this embodiment further has a memory 30 (shown in FIGS. 4 and 5) that holds a plurality of sets of image data including the first image data 40. The display device 6 has the function of switching between the plurality of sets of image data including the first image data 40. The memory 30 and the function of switching between the plurality of sets of image data will be described in detail below.

The display devices 6 in FIG. 1 are shown divided into three types, numbered 6A, 6B, and 6C, depending on the image display state of the display component 16. In FIG. 1, the display device 6A indicates the initial state. The display device 6B indicates when the display component 16 is displaying the first image data 40. The display device 6C indicates when the display component 16 is displaying second image data 41 (discussed below; shown in FIG. 6b). The “initial state” shown on the display device 6A refers to a state in which the first image data 40 in the memory 30 of the display device 6 has been deleted, or the state at the time of shipment of the display device 6 from the factory. The initial state in which the first image data 40 in the memory 30 has been deleted may be created by the display device 6A at a command from a server 9 before new first image data 40 is written to the pharmaceutical dispensing apparatus 5, or may be created by manipulation of the remote control 17.

### 1.1.2 Operation of Pharmaceutical Management System 1

As indicated by the dotted-line arrow in FIG. 1, prescription data produced by a physician using a terminal device, for example, in an examination room is first transmitted to and stored in the server 9 (this prescription data includes the patient's name, sex, and so forth). After this, the server 9 produces the first image data 40 in bitmap format to be displayed on the display device 6, on the basis of the prescription data.

The prescription data and the first image data 40 stored at the server 9 are sent respectively to a pharmaceutical dispensing unit 10 and a data writing unit 11 in the pharmaceutical dispensing apparatus 5.

The pharmaceutical dispensing unit 10 in the pharmaceutical dispensing apparatus 5 dispenses the pharmaceuticals 3 to the trays 4 on the basis of the prescription data received for each patient. Meanwhile, the data writing unit 11 in the pharmaceutical dispensing apparatus 5 sends the first image data 40 outputted and received from the server 9 to the display device 6A. The display device 6 holds the first image data 40 in the memory 30 in the display device 6 (shown in FIG. 4), and displays the first image data 40 on the display component 16. The display device to which the first image data 40 has been recorded is shown as the display device 6B in FIG. 1. The operations by which the first image data 40 is recorded and displayed here will be described in detail below.

The tray 4 into which the pharmaceuticals 3 have been dispensed and to which the display device 6B (the display device on which the first image data 40 is displayed) has been attached is discharged from the pharmaceutical dispensing apparatus 5. The discharged tray 4 is checked by a pharmacist in an inspection department 12 to see whether or not the correct pharmaceuticals 3 are on the tray 4.

The tray 4 is then temporarily placed on a cart 13.

After a plurality of trays 4 that have each been equipped with a display device 6B have been put on the cart 13, they are conveyed from the pharmaceutical department P to a nurses' station NS in the same hospital ward, for example. During this time, there is generally a non-confidential area where confidential information is not managed (NCA), such as a visitor area, along the conveyance route between the pharmaceutical department P and the nurses' station NS.

In view of this, in this embodiment, just before the cart 13 carrying the trays 4 to which the display devices 6B have been attached is carried out of the pharmaceutical department P, the first image data 40 that includes confidential information displayed on the screen of the display device 6B is switched over to second image data 41 that is non-confidential information (information that does not include confidential information). This second image data 41 is stored ahead of time in the memory 30 (shown in FIG. 4) inside the display device 6. This image switching control (an example of first image switching control) will be discussed in greater detail below.

As discussed above, the display components 16 of the display devices 6 on the cart 13 are all switched to display the second image data 41, which is non-confidential information. The display devices 6 in this state are shown as the display devices 6C in FIG. 1.

After this, the cart 13 carrying the trays 4 to which the display devices 6C have been attached is conveyed through the non-confidential area NCA to the nurses' station NS.

As shown in FIG. 1, the second image data 41 is displayed on the display components 16 of the display devices 6C attached to the trays 4 conveyed to the nurses' station NS. At the nurses' station NS, the trays 4 are taken to the rooms having the various patients' names, on the basis of the first image data 40 corresponding to prescription data, including the patients' names, sex, and so forth. The pharmaceuticals 3 are then administered to the patients. Therefore, the second image data 41 displayed on the display components 16 of the display devices 6C immediately after their conveyance to the nurses' station NS is switched to the first image data 40. The display devices 6 whose display has been switched here are shown in FIG. 1 as the display devices 6B. This switching control will be described in detail below.

At the nurses' station NS, the trays 4 to which the display devices 6B are attached are delivered to the patients in their rooms by nurses on the basis of the first image data 40. After this, the pharmaceuticals 3 in the trays 4 are administered to the patients.

The trays 4 from which the pharmaceuticals 3 have been administered are returned from the hospital rooms to the pharmaceutical department P. At this point the trays 4 to which the display devices 6 are attached are conveyed through the non-confidential area NCA. Thus, the first image data 40, including confidential information, displayed on the display components 16 of the display devices 6 is switched to the second image data 41, which is non-confidential information. The display devices 6 that have thus been switched are shown in FIG. 1 as the display devices 6C. The display devices 6C on whose display components 16 the second image data 41 was displayed are conveyed from the hospital rooms to the pharmaceutical department P. After this, the display on the display devices 6 of the trays conveyed to the pharmaceutical department P is switched from the second image data 41 to its initial state, for reuse in the pharmaceutical dispensing apparatus 5.

As discussed above, the pharmaceutical management system 1 in this embodiment is such that when the trays 4 to which the display devices 6 have been attached are taken out of the confidential information management area, the display components 16 of the display devices 6 display the second image data 41 (corresponds to the display devices 6C in FIG. 1), and when the trays 4 are in the confidential information management area (such as the pharmaceutical department P in FIG. 1, the hospital ward, etc.), the display components 16 display the first image data 40. This prevents confidential information from being displayed when the trays 4 are outside of the confidential information management area, and as a result prevents confidential information, including personal information, from being divulged to outsiders.

A display system 2 of the above-mentioned pharmaceutical management system 1 will now be described in further detail.

### 1.2 Display System 2

### 1.2.1 Configuration of Display System 2

The display system 2 in this embodiment includes the above-mentioned display device 6 and a remote control 17 that switches the image displayed on the display components 16 of the display devices 6.

### (1) Configuration of Display Devices 6

FIG. 2A is a front view of a display device 6 in this embodiment, and FIG. 2B is a side view of the same. The display device 6 includes a display device main body 18, a display component 16 consisting of an LCD, an organic EL display, or the like, and a transceiver 20 that sends and receives signals to and from the remote control 17 and the pharmaceutical dispensing apparatus 5.

First image data 40 is written by a data writing unit 11 to the display device 6. As discussed below, after the trays 4 to which the display devices 6 are attached go through the process from preparation to administration of the pharmaceuticals, and are returned to the pharmaceutical dispensing apparatus 5, the first image data 40 of the display devices 6 is deleted to return (or reset) the devices to their initial state, so they can be reused for any patient. The second image data 41 may be recorded to the display devices 6 in the initial state, or may be written and recorded simultaneously with the writing of the first image data 40.

### (2) Configuration of Remote Control 17

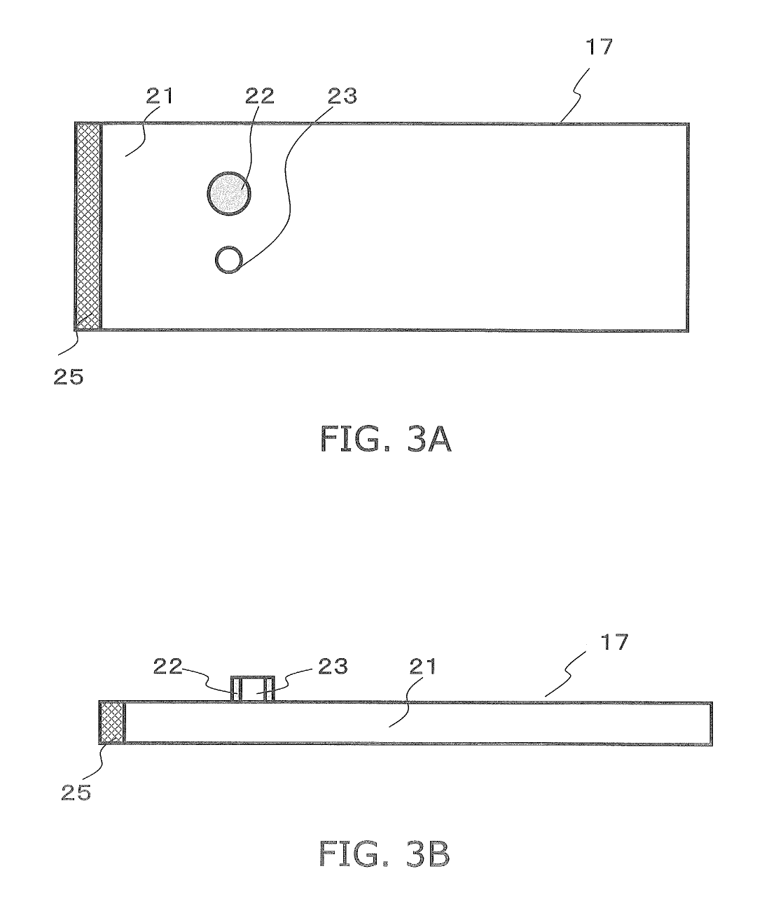

FIG. 3A is a front view of the remote control 17 in this embodiment, and FIG. 3B is a side view of the same. The remote control 17 includes a remote control main body 21, a first button 22 (an example of a manipulation component or first manipulation component), a second button 23 (an example of a manipulation component or second manipulation component), and a transmitter 25.

When the user (such as a pharmacist or a nurse) presses the first button 22, as will be discussed below, a first image switching signal is produced which is a command signal for switching between the first image data 40 and the second image data 41 at the display devices 6. When the user presses the second button 23, as will be discussed below, a second image switching signal is produced which is a command signal for switching between displaying and not displaying third image data 42 (shown in FIGS. 6c to 60, which is displayed superposed over the first image data 40. The transmitter 25 sends the inputted first image switching signal or second image switching signal to the display devices 6.

The remote control 17 is managed so that its use is permitted only for a specific user. The remote control 17 may be also managed so that it can be used only in a certain hospital ward, on a certain floor, or in a certain area.

### (3) Function of Display System 2

FIG. 4 is a function block diagram of the above-mentioned display system 2.

The remote control 17 further includes a remote control controller 24 that is connected to the above-mentioned first button 22 and second button 23 and receives signals from the first button 22 and second button 23, and that produces the above-mentioned first image switching signal or second image switching signal. The remote control controller 24 includes a first signal production component 46 and a second signal production component 47. The first signal production component 46 produces a first image switching signal, and the second signal production component 47 produces a second image switching signal. The image switching signals thus produced are outputted to the transmitter 25.

The display device 6 comprises a signal determination component 26 (an example of a determination component) that is connected to the above-mentioned transceiver 20 and receives signals from the transceiver 20, an image processor 27, a first image switching component 28, a second image switching component 29, the memory 30, and a display component controller 31 that controls the above-mentioned display component 16.

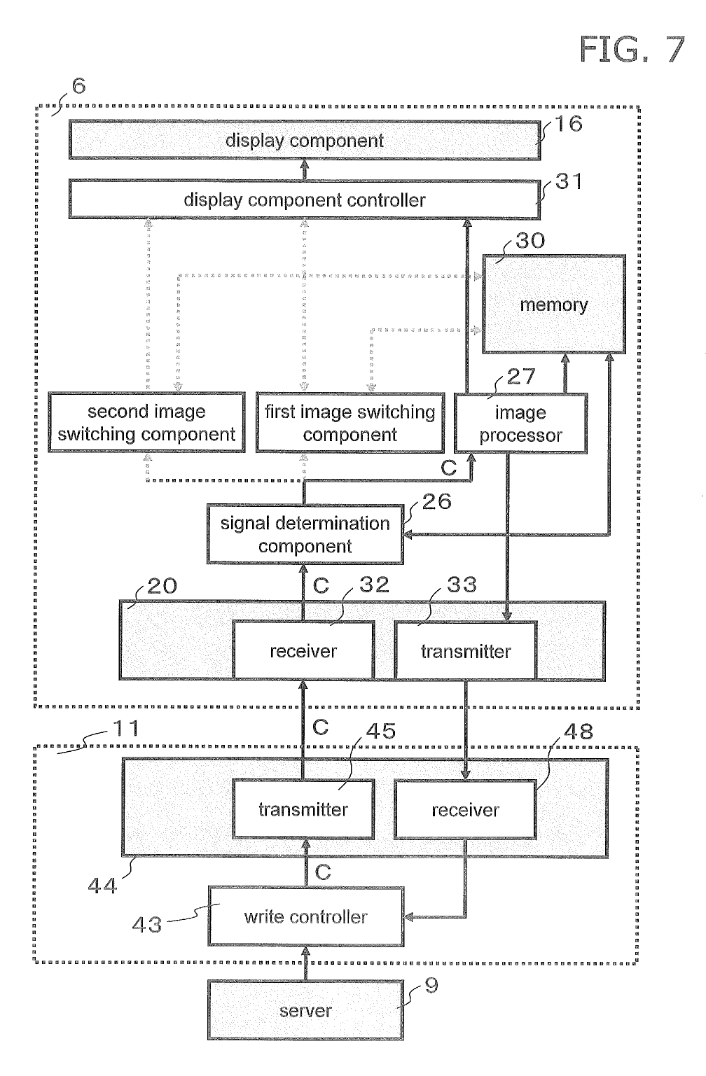

The transceiver 20 includes a receiver 32 and a transmitter 33. The receiver 32 receives signals outputted from the data writing unit 11 of the pharmaceutical dispensing apparatus 5 or the remote control 17. The transmitter 33 sends the data writing unit 11 of the pharmaceutical dispensing apparatus 5 completion signals produced by the image processor 27 of the display device 6, as shown in FIG. 7.

The signal determination component 26 decides whether a signal inputted from the receiver 32 is:

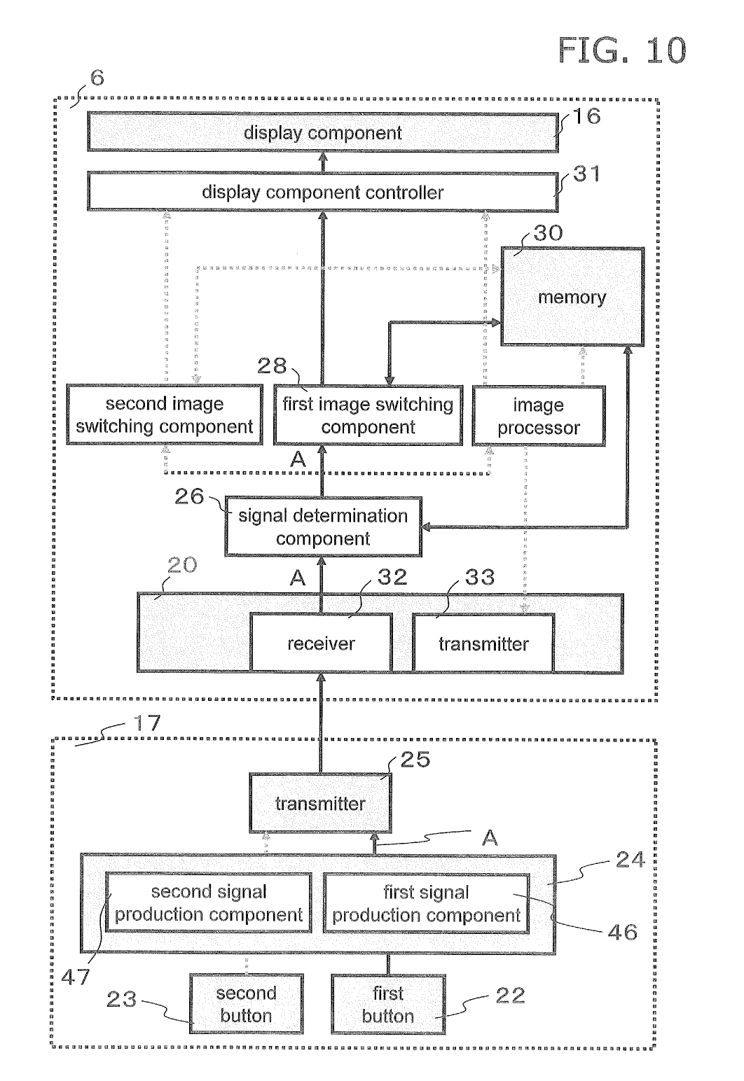

(A) the first image switching signal sent from the remote control 17 (signal A in FIG. 10);

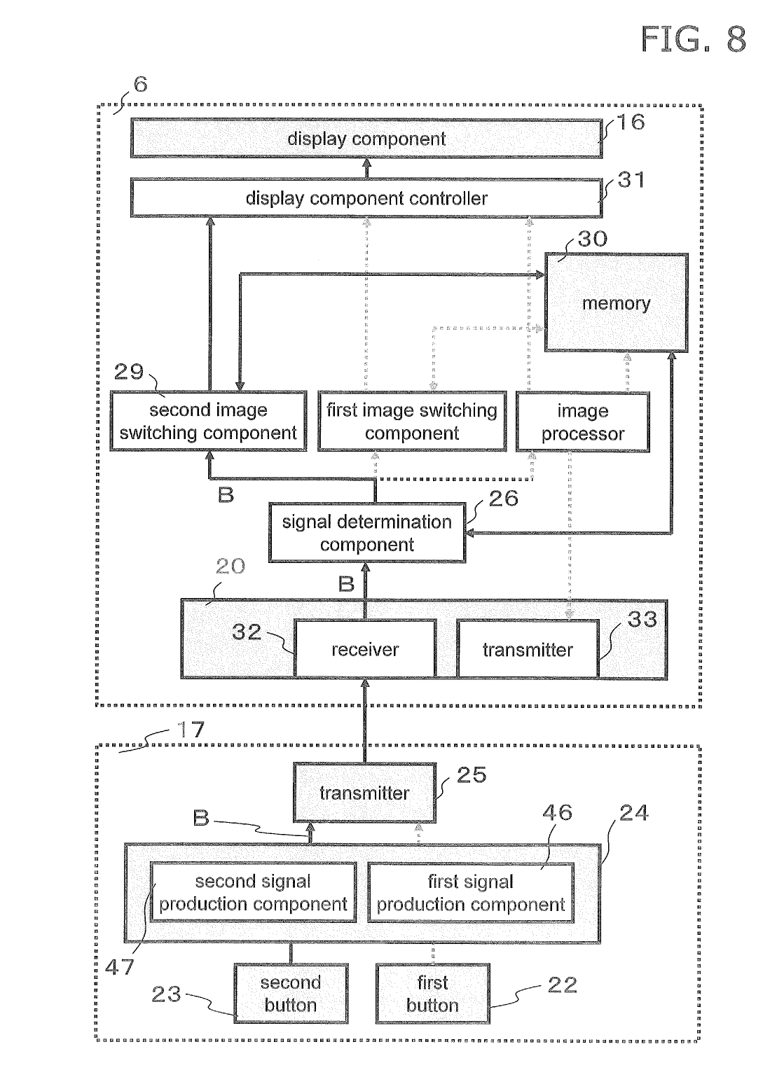

(B) the second image switching signal sent from the remote control 17 (signal B in FIG. 8); or

(C) a first image data signal from the data writing unit 11 of the pharmaceutical dispensing apparatus 5 (will be described in detail below; signal C in FIG. 7).

After this, it performs control so that the inputted signal:

(a) is outputted to the first image switching component 28 in the case of the first image switching signal A;

(b) is outputted to the second image switching component 29 in the case of the second image switching signal B; or

is outputted to the image processor 27 in the case of the first image data signal C.

In this embodiment, the decision among (A) to (C) is made, for example, by a method in which a command component is provided at the front end of the signals (A) to (C), and the decision about (A) to (C) is made by means of this command.

The image processor 27 performs processing according to the first image data signal C that is inputted, produces the first image data 40 to be displayed on the display component 16, and outputs this data to the display component controller 31 and the memory 30.

Upon receiving the inputted first image switching signal A, the first image switching component 28 reads the second image data 41 held in the memory 30, after which a command is outputted to the display component controller 31 to switch from the first image data 40 to the second image data 41. In this embodiment, the configuration is such that the system switches back and forth between the first image data 40 and the second image data 41 every time the first image switching signal A is inputted to the first image switching component 28.

Upon receiving the inputted second image switching signal B, the second image switching component 29 reads the third image data 42 held in the memory 30. After this, the second image switching component 29 outputs a command to the display component controller 31 to display the third image data 42 superposed over the first image data 40. In this embodiment, four types of third image data 42 are readied (which will be discussed in detail below). The second image switching component 29 displays these four types of third image data 42 (shown in FIGS. 6c to 60 in order and superposed over the first image data 40 every time the second image switching signal B is received.

The display component controller 31 displays the first image data 40 inputted from the image processor 27 on the display component 16. Upon receipt of a command signal from the first image switching component 28, the display on the display component 16 is switched alternately between the first image data 40 and the second image data 41. Furthermore, upon receipt of a command signal from the second image switching component 29, either the third image data 42 is displayed superposed over the first image data 40 displayed on the display component 16, or the third image data 42 is not displayed when third image data 42 is already being displayed.

The signal determination component 26, the image processor 27, the first image switching component 28, the second image switching component 29, and the display component controller 31 execute the above functions by having a processor execute programs held in the memory, for example.

The memory 30 holds the first image data 40 inputted from the image processor 27, and the pre-recorded second image data 41 and third image data 42. In this embodiment, an EEPROM (electrically erasable programmable read-only memory), for example, is used as the memory 30.

### (4) Image Data

FIG. 5 shows the image data recording state of the memory 30 of the display device 6 in Embodiment 1. As shown in FIG. 5, an area A34 in the memory 30 holds the first image data 40. An area A35 in the memory 30 holds the second image data 41. An area C36, an area D37, an area E38, and an area F39 in the memory 30 hold types of third image data 42 that are all different from each other.

FIG. 6 shows display examples of the first image data 40, the second image data 41, and the third image data 42 displayed by the display devices 6 in Embodiment 1. FIG. 6a shows a display example of the first image data 40, FIG. 6b shows a display example of the second image data 41, and FIGS. 6c to 6f show display examples of the third image data 42.

As shown in FIG. 6a, the first image data 40 is image data that includes confidential information such as the patient's name and sex, the hospital ward, the hospital room, the date, ID, and other such personal information.

As shown in FIG. 6b, the second image data 41 is image data that is non-confidential information, that is, it is not personal information or other such confidential information. In this embodiment, the second image data 41 is “◯◯◯◯ General Hospital,” which is the user name of the pharmaceutical management system 1. The second image data 41 may be anything, as long as it is image data that may be divulged to the public at large (outsiders).

The third image data 42A, 42B, 42C, and 42D shown in FIGS. 6c to 6f are image data displayed simultaneously with the first image data 40, and include information indicating at what stage the pharmaceuticals 3 in the trays 4 are (the pharmaceutical status). The dispensed pharmaceuticals 3 are prepared and inspected in the pharmaceutical department P. After this, the pharmaceuticals 3 go through the nurses' station NS and are administered to the patient, and the trays 4 are returned to the pharmaceutical dispensing apparatus 5. In this embodiment, the third image data 42A (prepared), 42B (inspected), 42C (administered), and 42D (return) are each displayed on the display component 16 superposed over the first image data 40. This allows the user to see where the trays 4 equipped with the display devices 6 are located in the pharmaceutical management system 1 at the hospital in FIG. 1 (which area in FIG. 1). Thus, the pharmacist or nurse who is actually handling the trays 4 can check on where the trays 4 are currently located. Which of the third image data 42A to 42D is to be displayed superposed over the first image data 40 will be discussed in detail below.

The above is a description of the configuration of the display system 2 (the display device 6 and the remote control 17).

### 1.2.2 Operation of Display System 2

Next, the operation of the display system 2 in this embodiment will be described.

The display system 2 in this embodiment performs:

(1) control over the writing of the first image data 40 from the data writing unit 11 of the pharmaceutical dispensing apparatus 5 to the display device 6, and control over the display of the first image data 40,

(2) control over second image switching of the display device 6, and

(3) control over first image switching of the display device 6.

The control performed in (1) to (3) above will now be described in detail.

(1) Control over the writing of the first image data 40 from the data writing unit 11 of the pharmaceutical dispensing apparatus 5 to the display device 6

FIG. 7 shows control over the writing and display of the first image data 40 from the data writing unit 11 of the pharmaceutical dispensing apparatus 5 to the display device 6. Here, the data writing unit 11 of the pharmaceutical dispensing apparatus 5 includes a write controller 43 and a transceiver 44 having a transmitter 45 and a receiver 48.

The server 9 produces the bitmap-format first image data 40 to be displayed on the display device 6 on the basis of inputted prescription data, as described for the pharmaceutical management system 1 in a hospital through reference to FIG. 1.

After this, as shown in FIG. 7, the server 9 outputs the first image data 40 to the write controller 43 inside the data writing unit 11 of the pharmaceutical dispensing apparatus 5. The write controller 43 to which the first image data 40 has been inputted converts the first image data 40 into data that can be transmitted wirelessly, and outputs this converted signal as a first image data signal C to the transmitter 45 of the transceiver 44 inside the data writing unit 11. At this point, the first image data signal C includes, in addition to the first image data 40, identification information about the data writing unit 11. After this, the transmitter 45 sends the first image data signal C to the receiver 32 inside the transceiver 20 of the display device 6.

In this embodiment, communication between the display device 6 and the data writing unit 11 of the pharmaceutical dispensing apparatus 5, and communication between the remote control 17 and the display device 6 (discussed below) make use of infrared communication that conforms to the IrDA (Infrared Data Association) standard.

The receiver 32 of the display device 6 that has received the first image data signal C converts (or demodulates) the received electrical signal and outputs the result to the signal determination component 26. The signal determination component 26 authenticates the inputted signal. “Authentication” here means identifying the data writing unit 11 by evaluating the correspondence between identification information about the data writing unit 11 included in the inputted signal, and identification information about the data writing unit 11 stored in the memory 30 of the display device 6 in advance. This authentication prevents the image data of the display device 6 from being rewritten by a non-compliant data writing unit 11.

As discussed above, the signal determination component 26 then determines the signal to be either the first image switching signal A, the second image switching signal B, or the first image data signal C. The signal determination component 26 outputs the signal to either the image processor 27, the first image switching component 28, or the second image switching component 29 according to what the signal was determined to be. Here, the first image data signal C has been inputted, so the first image data signal C is outputted to the image processor 27.

As discussed above, the image processor 27 performs processing of the inputted first image data signal C, produces the first image data 40 for display on the display component 16, and outputs this to the display component controller 31 and the memory 30.

After this, the display component controller 31 displays the first image data 40 inputted from the image processor 27 on the display component 16. FIG. 6a shows an example of the first image data 40 at this point.

After this, the image processor 27 confirms that the first image data 40 has been displayed on the display component 16 and that recording to the memory 30 has been completed, and outputs this completion signal to the transmitter 33 in the transceiver 20. The transmitter 33 then sends this completion signal to the receiver 48 of the data writing unit 11 of the pharmaceutical dispensing apparatus 5.

The data writing unit 11 that has received this completion signal determines that the writing of the first image data 40 to the current display device 6 is complete, and outputs a write completion signal to the controller (not shown) of the pharmaceutical dispensing apparatus 5. Upon receiving this write completion signal, the controller of the pharmaceutical dispensing apparatus 5 begins the next operation in the pharmaceutical dispensing apparatus 5.

The above is the control over the writing of the first image data 40 from the data writing unit 11 of the pharmaceutical dispensing apparatus 5 to the display device 6.

(2) Control Over Second Image Switching of the Display Device 6

Next, we will describe control over second image switching of the display device 6. FIG. 8 is a block diagram of the control over second image switching of the display device 6 in Embodiment 1.

When the second button 23 on the remote control 17 is pressed, the second signal production component 47 inside the remote control controller 24 produces the second image switching signal B. The second image switching signal B that is sent here includes identification information about the remote control 17. This second image switching signal B is outputted from the remote control controller 24 to the transmitter 25. The transmitter 25 then sends the second image switching signal B to the receiver 32 inside the transceiver 20 of the display device 6.

In this embodiment, communication between the display device 6 and the remote control 17 makes use of infrared communication that conforms to the IrDA (Infrared Data Association) standard.

The receiver 32 of the display device 6 that has received the second image switching signal B converts (or demodulates) the received electrical signal and outputs the result to the signal determination component 26. The signal determination component 26 authenticates the inputted signal. “Authentication” here means identifying the remote control 17 by evaluating the correspondence between identification information about the remote control 17 included in the inputted signal, and identification information about the remote control 17 stored in the memory 30 of the display device 6 in advance. This authentication prevents the image data of the display device 6 from being rewritten by a non-compliant remote control 17.

As discussed above, the signal determination component 26 then determines the signal to be either the first image switching signal A, the second image switching signal B, or the first image data signal C. The signal determination component 26 outputs the signal to either the image processor 27, the first image switching component 28, or the second image switching component 29 according to what the signal was determined to be. Here, the second image switching signal B has been inputted, so the second image switching signal B is outputted to the second image switching component 29.

Upon receiving the second image switching signal B, the second image switching component 29 reads one of the third image data 42A to 42D (FIG. 6) stored in the memory 30. After this, the third image data 42A to 42D that was read is outputted to the display component controller 31, and a command signal is outputted so that one of the third image data 42A to 42D will be displayed superposed over the first image data 40. The second image switching component 29 also outputs a command signal indicating no display when the third image data 42 is being displayed when second image switching signal B is received.

In this embodiment, every time the second image switching signal B is received, selection switching control is performed in the order of no third image data selected (no display of third image data), the third image data 42A (such as “prepared”), the third image data 42B (such as “inspected”), the third image data 42C (such as “administered”), the third image data 42D (such as “return”), no third image data selected, and so on. Every time the second image switching signal B is received and switched, at least information related to the third image data that was being displayed just prior to the third image data that is now being displayed (information such as identification information, flags, image data itself) is stored in the memory 30. When the second image switching signal B is received, the next set of third image data is specified and displayed on the basis of recorded information related to the third image data that came immediately prior.

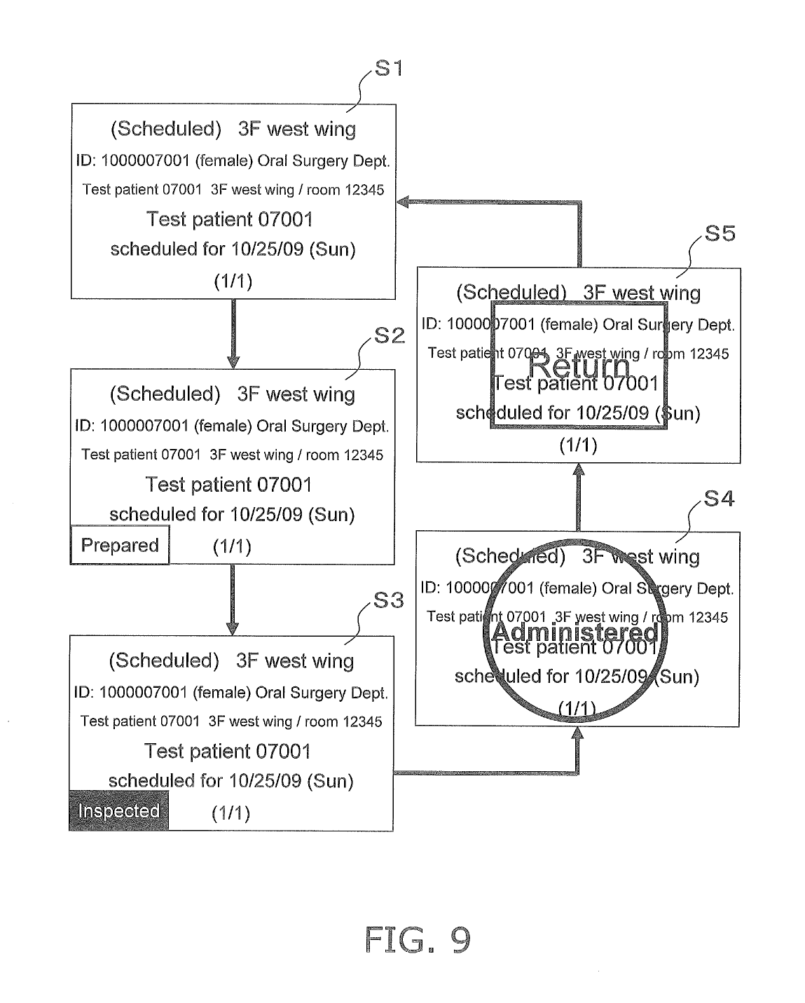

FIG. 9 shows the change in the image display state on the display component 16 when second image switching control is performed by the above-mentioned display system 2.

As shown in FIG. 9, in this embodiment, every time the second image switching signal B is received, the display component 16 of the display device 6 is switched so as to go through the following cycle:

S1: first image data 40

S2: first image data 40+third image data 42A

S3: first image data 40+third image data 42B

S4: first image data 40+third image data 42C

S5: first image data 40+third image data 42D

The image data in S1 to S5 always includes the first image data 40. The above is the second image switching control of the display device 6.

(3) Control Over First Image Switching of the Display Device 6

Next, the first image switching control of the display device 6 will be described. FIG. 10 is a block diagram of the first image switching control of the display device 6 in Embodiment 1.

When the first button 22 on the remote control 17 is pressed, the first signal production component 46 inside the remote control controller 24 produces the first image switching signal A. The first image switching signal A that is sent here includes identification information about the remote control 17. This first image switching signal A is outputted from the remote control controller 24 to the transmitter 25. The transmitter 25 then sends the first image switching signal A to the receiver 32 inside the transceiver 20 of the display device 6.

In this embodiment, communication between the display device 6 and the remote control 17 makes use of infrared communication that conforms to the IrDA (Infrared Data Association) standard.

The receiver 32 of the display device 6 that has received the first image switching signal A converts (or demodulates) the received electrical signal and outputs the result to the signal determination component 26. The signal determination component 26 authenticates the inputted signal. “Authentication” here means identifying the remote control 17 by evaluating the correspondence between identification information about the remote control 17 included in the inputted signal, and identification information about the remote control 17 stored in the memory 30 of the display device 6 in advance. This authentication prevents the image data of the display device 6 from being rewritten by a non-compliant remote control 17.

As discussed above, the signal determination component 26 then determines the signal to be either the first image switching signal A, the second image switching signal B, or the first image data signal C. The signal determination component 26 outputs the signal to either the image processor 27, the first image switching component 28, or the second image switching component 29 according to what the signal was determined to be. Here, the first image switching signal A has been inputted, so the first image switching signal A is outputted to the first image switching component 28.

Upon receiving the first image switching signal A, the first image switching component 28 performs the image switching control in either (A) or (B) below (an example of first image switching control).

(A) If the display component 16 is currently displaying an image that includes the first image data 40, then the second image data 41 is read from the memory 30, and this second image data 41 is outputted to the display component controller 31. After this, information is acquired from the display component controller 31 about which data is being displayed among the third image data 42A to 42D (specifically, which of the images of S1 to S5 in FIG. 9 is being displayed), that is, information related to the above-mentioned immediately preceding third image data, and this information is recorded to the memory 30.

(B) If the display component 16 is currently displaying an image that includes the second image data 41, then information is read from the memory 30 about which of the data has been displayed among the third image data 42A to 42D by the display component controller 31 (specifically, which of the images of S1 to S5 in FIG. 9 has been displayed), that is, information related to the immediately preceding third image data. After this, on the basis of that information, the first image data 40 and the immediately preceding third image data 42A to 42D (specifically, one of the images of S1 to S5 in FIG. 9) are read, and outputted to the display component controller 31.

Thus, every time the first image switching signal A is received, the first image switching component 28 switches between the second image data 41 and the image data (S1 to S5) including at least the first image data 40.

As discussed above, image data that includes at least the image data of S1 to S5 will always include the first image data 40. Also, as described in (1) above, the first image data 40 includes the patient's name and sex, the hospital ward, the hospital room, the date, ID, and other such personal information. Specifically, the image data (S1 to S5) that includes at least the first image data 40 is image data that includes confidential information.

To put this another way, when the first image switching signal A is inputted and the image on the display component 16 is the first image data 40, the first image switching component 28 switches the image displayed on the display component 16 from the first image data 40 to the second image data 41. Alternatively, when the first image switching signal A is inputted and the image on the display component 16 is the second image data 41, the first image switching component 28 switches the image displayed on the display component 16 from the second image data 41 to the first image data 40.

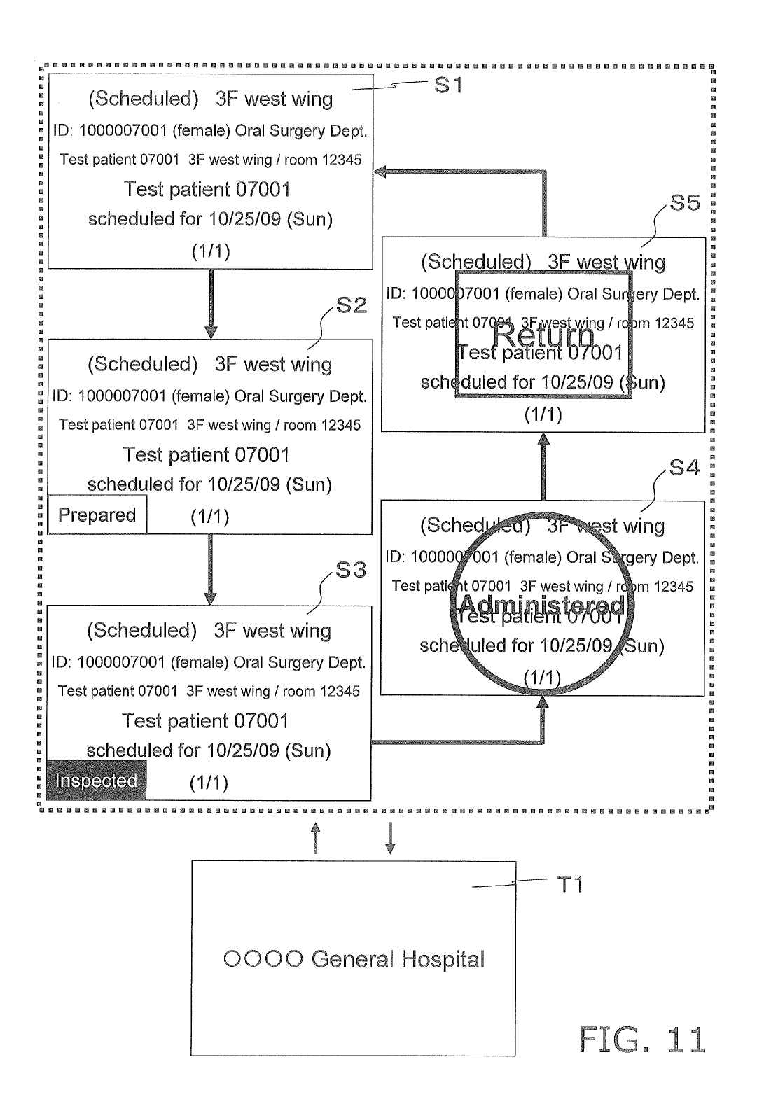

FIG. 11 shows the transition in the image display state on the display component 16 when the above-mentioned image switching control is performed by the display system 2.

In this embodiment, as shown in FIG. 11, every time the first image switching signal A is received, the display component 16 of the display device 6 is alternately switched between:

T1: the second image data 41 and one of the following:

S1: first image data 40

S2: first image data 40+third image data 42A

S3: first image data 40+third image data 42B

S4: first image data 40+third image data 42C

S5: first image data 40+third image data 42D

The above is the first image switching control of the display device 6.

(4) Preventing Malfunction after First Image Switching Control in this Embodiment

Next, the control performed by the above-mentioned display system 2 in this embodiment, and other characteristics, will be described.

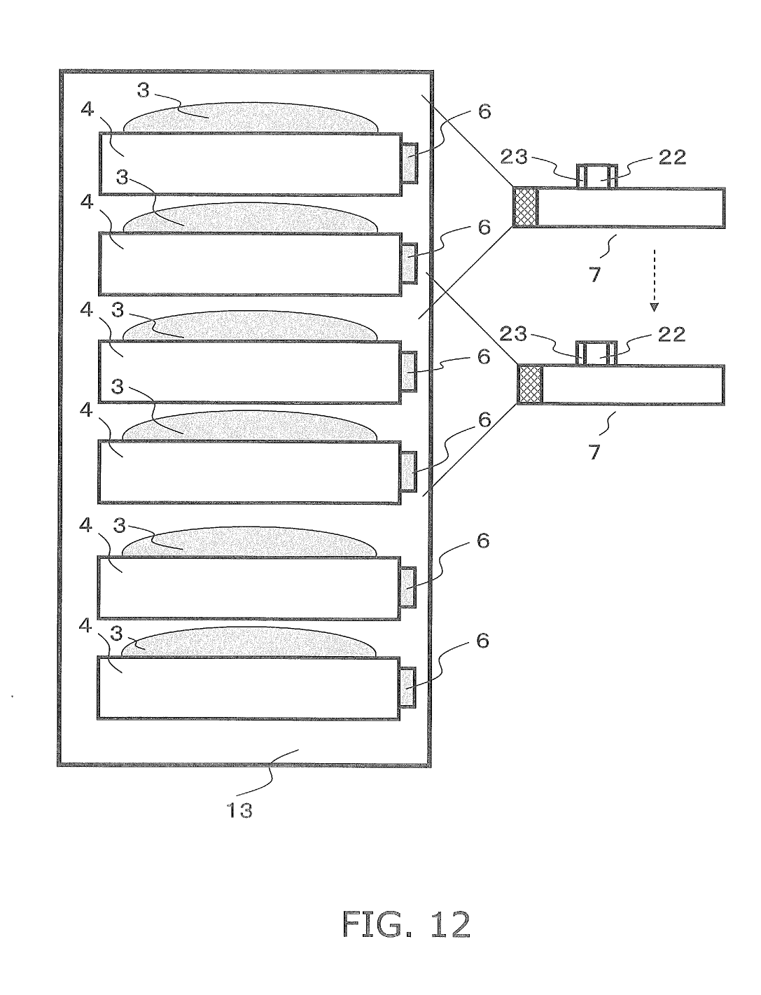

FIG. 12 shows an example of operation of the remote control 17 when image switching control between the first image data 40 and the second image data 41 is performed in this embodiment.

As described in (1) above, the trays 4 to each of which is attached a display device 6 are loaded onto the cart 13, and then conveyed from the pharmaceutical department P to the nurses' station NS in the hospital ward. When the cart goes through a non-confidential area NCA along the way, the display on the display component 16 on each tray 4 is switched from the first image data 40 to the second image data 41. In this embodiment, a single remote control 17 is used to switch the display of a plurality of display devices 6 at once, as shown in FIG. 12.

In this embodiment, image switching control of the plurality of display devices 6 is performed by operating the remote control 17 one time, but as shown in FIG. 12, the first button 22 must be pressed successively a plurality of times while moving the remote control 17 in order to switch the images on all of the display devices 6. However, if the range of the infrared beam in infrared communication according to the IrDA standard of the remote control 17 overlaps the range during the previous operation, there is the possibility of a malfunction in which the image display is put back to the previous image (the first image data 40 here) even though it has already been switched to the desired image (the second image data 41 here).

Therefore, in this embodiment, a reception disabled period is provided in which reception of the first image switching signal A by the display device 6 is disabled for a specific length of time after the execution of image switching control between the first image data 40 and the second image data 41. As a result, a malfunction after the execution of image switching control can be prevented.

### 1.3 Control by Display System 2

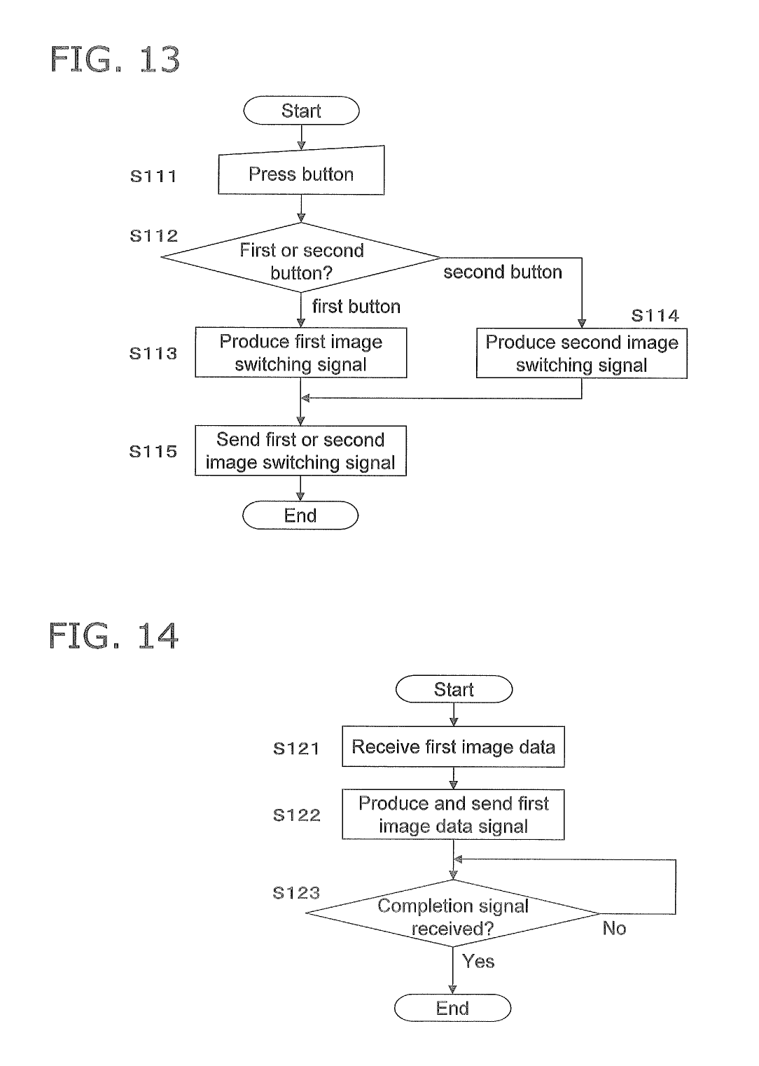

The flow of control by the display system 2 will be described through reference to FIGS. 13 to 15.

### 1.3.1 Control by Remote Control 17

FIG. 13 shows the flow of control by the remote control 17 (shown in FIG. 4).

Step S111: The user operates a button on the remote control 17.

Step S112: The remote control controller 24 determines whether the signal was inputted from the first button 22 or the second button 23. If the signal was inputted from the first button 22, the flow proceeds to step S113, but if the signal was inputted from the second button 23, the flow proceeds to step S114.

Step S113: The first image switching signal A is produced by the first signal production component 46 of the remote control controller 24.

Step S114: The second image switching signal B is produced by the second signal production component 47 of the remote control controller 24.

Step S115: The image switching signal produced in step S113 or step S114 is sent by the transmitter 25 to the display device 6.

### 1.3.2 Control by Remote Control 17

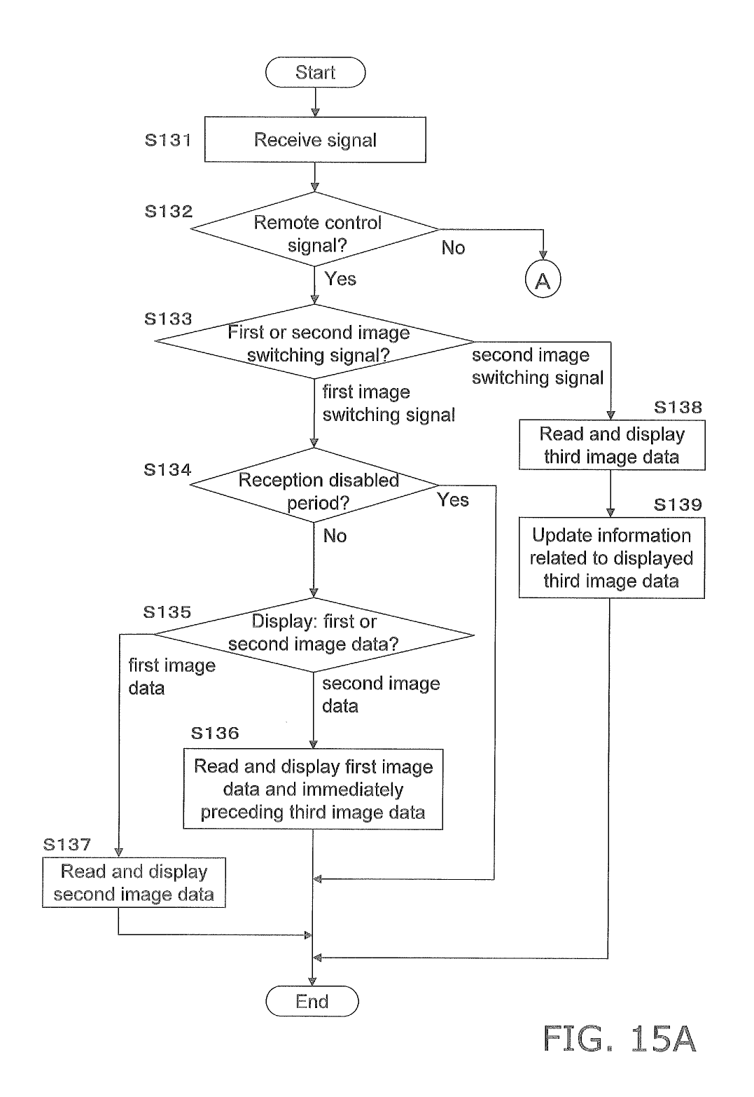

FIG. 14 shows the flow of control by the data writing unit 11 of the pharmaceutical dispensing apparatus 5 (shown in FIG. 7).

Step S121: The data writing unit 11 receives the first image data 40 produced on the basis of prescription data at the server 9.

Step S122: The first image data 40 is converted by the write controller 43 into the first image data signal C. The first image data signal C is then sent through the transmitter 45 to the display device 6.

Step S123: The receiver 48 ends the processing when a completion signal has been received indicating that the first image data 40 has been received and recorded the first image data 40 by the display device 6.

### 1.3.3 Control by Display Device 6

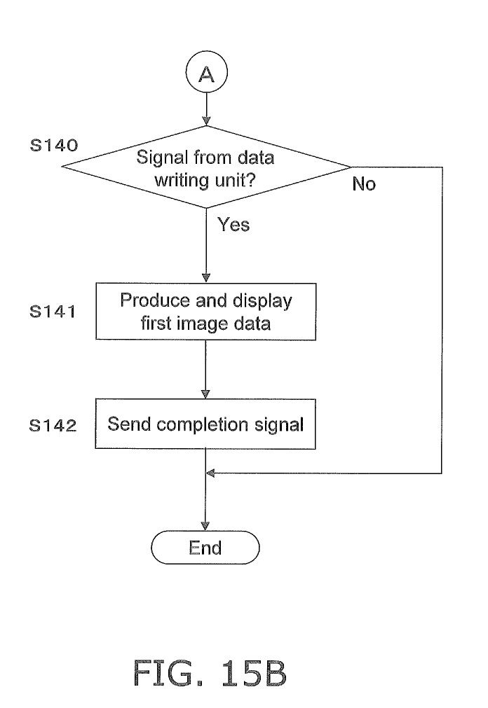

FIGS. 15A and 15B show the flow of control by the display device 6 (shown in FIG. 4).

Step S131: The receiver of the display device 6 receives the signal.

Step S132: The signal determination component 26 determines whether or not the received signal is a signal from the remote control 17. As discussed above, this is performed by determining whether or not the identification information about the remote control 17 included in the received signal corresponds to the pre-recorded identification information. If authentication of the identification information about the remote control 17 is successful, the flow proceeds to step S132, and otherwise the flow proceeds to step S140 (FIG. 15B).

Step S133: The signal determination component 26 determines whether the received signal is a first image switching signal or a second image switching signal. If it is a first image switching signal, the flow proceeds to step S134, and if it is a second image switching signal, the flow proceeds to step S138.

Step S134: The first image switching component 28 determines whether or not the first image switching signal is within the reception disabled period, and ends the processing if it is within the reception disabled period, but otherwise the flow proceeds to step S135.

Step S135: The first image switching component 28 determines whether the image data being displayed on the display component 16 is the first image data 40 or the second image data 41. If it is the first image data 40, the flow proceeds to step S137, but if it is the second image data 41, the flow proceeds to step S136.

Step S136: The first image switching component 28 reads the first image data 40 and the immediately preceding third image data (including no display) from the memory 30, and displays them on the display component 16 via the display component controller 31.

Step S137: Meanwhile, the first image switching component 28 reads the second image data from the memory 30, and displays it on the display component 16 via the display component controller 31.

Step S138: If the signal received in step S133 is a second image switching signal, the second image switching component 29 reads the next set of the immediately preceding third image data (including no display) from the memory 30, and displays it on the display component 16 via the display component controller 31.

Step S139: Information related to the last set of third image data to be displayed is updated in the memory 30.

Step S140: Meanwhile, if the signal received in step S132 is not a signal from the remote control 17, the signal determination component 26 determines whether or not the signal is from the data writing unit 11, and if it is a signal from the data writing unit 11, the flow proceeds to step S141.

Step S141: The image processor 27 produces the first image data 40 on the basis of the received signal, and displays it on the display component 16 via the display component controller 31. The first image data 40 is also stored in the memory 30.

Step S142: The transmitter 33 sends a completion signal to the data writing unit 11.

The above control flow is an example, and the procedure and the number of processing steps are not limited to what is given above. For instance, the order of step S132 (authentication of the remote control 17) and step S140 (authentication of the data writing unit 11) may be reversed.

### 1.4 Other Characteristics in this Embodiment

The display device 6 in this embodiment is configured so that a command to start first image switching control can be executed only from an external device (the remote control 17 in this embodiment) that is compatible with the display device 6. Furthermore, the configuration is such that image switching control using this external device (switching between the first image data 40 and the second image data 41) can be executed only in the area in which confidential information is managed (such as the pharmaceutical department P or the nurses' station NS).

More specifically, in this embodiment, at least one remote control 17 is provided in the pharmaceutical department P and in the nurses' station NS, and the staff is prohibited from taking these out of areas where confidential information is managed, namely, the pharmaceutical department P and the nurses' station NS.

Specifically, with the display system 2, image switching control between the first image data 40 and the second image data 41 by the display device 6 can only be directed from an external device of the display device 6. Furthermore, it is forbidden to take the external device that performs the image switching control of the display device 6 in the display system 2 out of an area in which confidential information is managed. Consequently, when the trays 4 are outside the area of confidential information management, there is less risk that confidential information including personal information will be divulged intentionally to an outsider, such as by the theft of the display device 6. As a result, leakage of confidential information including personal information can be effectively prevented.

### 1.5 Effect of Embodiment 1

As discussed above, the display system 2 in this embodiment comprises a display device 6 that holds first image data 40 including confidential information, and second image data 41 that is non-confidential information, and displays the first image data 40 and the second image data 41, as well as a remote control 17 that has manipulation components 22 and 23 for producing and sending signals to the display device 6. The remote control 17 has a first signal production component 46 that produces a first image switching signal A that is a command signal for switching between the first image data 40 and the second image data 41 according to operation of the manipulation components 22 and 23 by a specific user, and a transmitter 25 that sends the first image switching signal A to the display device 6. The display device 6 has a receiver 32 that receives the first image switching signal A from the remote control 17, a first image switching component 28 that directs switching between the first image data 40 and the second image data 41 according to the first image switching signal A, and a display component 16 that displays the first image data 40 or the second image data 41 according to the command from the first image switching component 28. The first image switching component 28 executes first image switching control in which when the first image switching signal A is inputted, the second image data 41 is displayed on the display component 16 if the first image data 40 is being displayed on the display component 16, and the first image data 40 is displayed on the display component 16 if the second image data 41 is being displayed on the display component 16. Accordingly, when the tray 4 on which this display device 6 is used is taken out of an area in which confidential information is managed, the display device 6 displays the second image data 41, and when the tray 4 is within an area in which confidential information is managed, the display component 16 displays the first image data 40. Consequently, no confidential information will be displayed when the trays 4 are out of the confidential information management area, and as a result, confidential information including personal information can be effectively prevented from being divulged to an outsider.

With the display system 2 in this embodiment, the display device 6 disables the reception of any new first image switching signals for a specific length of time after the execution of image switching control between the first image data 40 and the second image data 41. This prevents malfunction after image switching operation.

With the display system 2 in this embodiment, the remote control 17 further has a second signal production component 47 that produces a second image switching signal B, which is a command signal for switching between displaying and not displaying one or more sets of third image data 42 according to the operation of the manipulation components 22 and 23 by a specific user. Furthermore, the display device 6 holds one or more sets of third image data 42, receives the second image switching signal B by the receiver 32, and has a second image switching component 29 that directs switching between displaying and not displaying the third image data 42 according to this second image switching signal B, and the display component 16 displays the third image data 42 superposed over the first image data 40 according to the command from the second image switching component 29. This makes the display system 2 more convenient to use.

With the display system 2 in this embodiment, there are a plurality of sets of third image data 42, and the second image switching component 29 switches among the plurality of sets of the third image data 42 and image data with no third image data on the display component 16 in order, every time the second image switching signal B is inputted. This makes the display system 2 more convenient to use.

With the display system 2 in this embodiment, the manipulation components of the remote control 17 include the first button 22 and the second button 23, the first signal production component 46 produces the first image switching signal A in response to operation of the first button 22 by a specific user, and the second signal production component 47 produces the second image switching signal B in response to operation of the second button 23 by a specific user. This makes it easy to manage the pharmaceuticals placed in the trays 4, and to manage confidential information. Also, manipulation error by the user can be prevented, which lessens the burden on user manipulation.

With a pharmaceutical management system 1 using the display system 2 pertaining to this embodiment, the display device 6 displays the second image data 41 on the display component 16 when the tray 4 has been taken out of an area in which confidential information is managed (corresponds to the display device 6C in FIG. 1), and displays the first image data 40 on the display component 16 when the tray 4 is in a confidential information management area (such as the pharmaceutical department P, a hospital ward in FIG. 1). Consequently, confidential information including personal information can be prevented from being divulged to an outsider.

### 2. Other Embodiments

Embodiments of the present invention are not limited to the embodiment given above, and various modifications, changes, and combinations are possible without departing from the gist of the invention. Also, the above embodiment is essentially just a preferred example, and is not intended to limit the present invention, its applications, or the scope of these applications. The following modifications are possible, for example.

### 2.1

In the above embodiment, the display device 6 determines the correspondence between identification information about the remote control 17 included in the second image switching signal or the first image switching signal A sent from the remote control 17, and identification information about the remote control 17 stored ahead of time in the memory 30 by the display device 6, and performs authentication if there is a match. Alternatively, the display device 6 may determine the correspondence between identification information included in the first image data sent by the data writing unit 11, and identification information about the remote control 17 included in the second image switching signal or the first image switching signal A. In this case, the identification information included in the first image data is information that is associated with identification information about the remote control 17.

For example, when a plurality of remote controls 17 assigned different ID's are used, the identification information for the remote control 17 recorded to the display device 6 will have to be changed every time first image data is written to the display device 6. However, if the authentication of the remote control 17 is performed using the identification information included in the image data sent by the data writing unit 11, then there will be no need to change the identification information for the remote control 17 recorded to the display device 6. Also, even when a plurality of remote controls 17 assigned different ID's are used, the display device 6 can be reused after resetting, without having to update the ID's of the remote controls 17 on the display device 6 side.

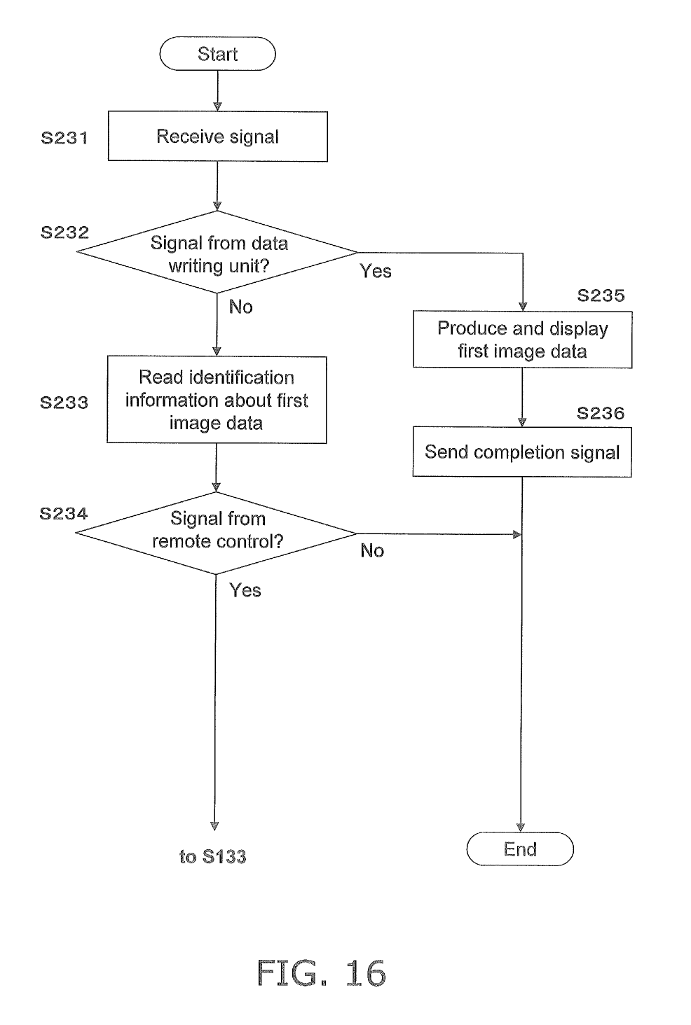

FIG. 16 shows the flow of the above-mentioned control performed by the display device 6. Steps S231 to S236 involve processing corresponding to steps S131 to 130 in FIG. 15A and steps S140 to S142 in FIG. 15B in the above embodiment.

Step S231: The receiver 32 of the display device 6 receives a signal.

Step S232: The signal determination component 26 determines whether or not the signal is from the data writing unit 11. If the signal is not from the data writing unit 11, the flow proceeds to step S233, and if the signal is from the data writing unit 11, the flow proceeds to step S235.

Step S233: The signal determination component 26 reads the identification information about the remote control 17 included in the first image data from the memory 30.

Step S234: The signal determination component 26 determines the correspondence between the identification information about the first image data that was read, and the identification information about the remote control 17 included in the received signal. If the identification information matches, the flow proceeds to step S133 in FIG. 15A, after which the same processing as in Embodiment 1 is performed. If the identification information does not match, the processing is ended.

Step S235: The image processor 27 produces the first image data 40 on the basis of the received signal, and displays it on the display component 16 via the display component controller 31. The first image data 40 is stored in the memory 30.

Step S236: The transmitter 33 sends a completion signal to the data writing unit 11.

### 2.2

In Embodiment 1 above, the display system 2 was applied to the pharmaceutical dispensing apparatus 5, which was used in a hospital, but this is not the only option. For example, it can also be utilized as a display system that makes use of a display device attached to a part container that is conveyed between manufacturing lines in a factory. In this case, confidential information such as a name specifying a part, the manufacturing step, and so forth is displayed on the display device in an area along the conveyance path in which confidential information is managed, and the display is switched to non-confidential information outside this confidential information management area. Similarly, the display system 2 can be utilized as a display system that makes use of a display device for displaying the contents of packages or mail being delivered.

### 2.3

In Embodiment 1 above, two manipulation components (buttons) were provided to the remote control, but there may be only one, or there may be three or more. If there is just one button, then every time the button is pressed, for example, the display is switched in the order of first image data 40, first image data 40+third image data 42A (prepared), first image data 40+third image data 42B (inspected), second image data 41+third image data 42C (administered), first image data 40+third image data 42D (return), first image data 40, and so forth.

### 2.4

The remote control 17 may have the function of verifying the user. The verification function can be, for example, an ID card carried by the user, a code authentication used with a portable device, a biometric verification of the user, etc.

### 2.5

In the above embodiment, a reception disabled period was provided in which reception of the first image switching signal A by the display device 6 was disabled for a specific length of time after the execution of first image switching control. This reception disabled period may be set or not set for each area. For example, in the above embodiment, a case in which the displays of first image data on a plurality of display devices 6 are switched all at once is usually during first image switching control performed in a confidential information management area. Thus, a means for determining that the display device 6 is in such a region as confidential information management area (for example, an area detector that uses a sensor) is provided to the display device 6, and reception of the first image switching signal A is disabled when the display device 6 is outside this area. This avoids the inconvenience of having to disable the first image switching signal A.

### 2.6

In the above embodiment, when the first image switching signal A is received while the first image data 40 and third image data are being displayed on the display component 16, the display device 6 may leave the third image data displayed or switch it to the second image data 41. This is limited to a situation in which the third image data is not confidential information, however.

In this case, an advantage is that the user can ascertain the status of pharmaceutical even when the second image data 41 is being displayed.

### 2.7

With the present invention, control by the display system 2 need not include first image data write control by the data writing unit 11 of the pharmaceutical dispensing apparatus 5 over the display device 6. Also, the present invention can be worked as a display control method, and not just as the display system 2 or the display device 6.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the three-dimensional image processing apparatus, three-dimensional image-pickup apparatus, three-dimensional image-pickup method, and program. Accordingly, these terms, as utilized to describe the present invention should be interpreted relative to the three-dimensional image processing apparatus, three-dimensional image-pickup apparatus, three-dimensional image-pickup method, and program.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed. While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

### REFERENCE SIGNS LIST

1 pharmaceutical management system
3 pharmaceutical
4 tray (an example of a conveyance container)
5 pharmaceutical dispensing apparatus
6, 6A, 6B, 6C display device
9 server
10 pharmaceutical dispensing unit
11 data writing unit
12 inspection unit
13 cart
16 display component
17 remote control
18 display device main body
20 transceiver
21 remote control main body
22 first button (an example of a manipulation component or a first manipulation component)
23 second button (an example of a manipulation component or a second manipulation component)
24 remote control controller
25 transmitter (of remote control)
26 signal determination component (an example of a determination component)
27 image processor
28 first image switching component
29 second image switching component
30 memory
31 display component controller
32 receiver (of display device)
33 transmitter (of display device)
34 area A
35 area B
36 area C
37 area D
38 area E
39 area F
40 first image data
41 second image data
42, 42A, 42B, 42C, 42D third image data
43 write controller
44 transceiver (of data writing unit)
45 transmitter (of data writing unit)
46 first signal production component
47 second signal production component
48 receiver (of data writing unit)
A first image switching signal
B second image switching signal
C first image data signal
S1 first image data 40
S2 first image data 40+third image data 42A
S3 first image data 40+third image data 42B
S4 first image data 40+third image data 42C
S5 first image data 40+third image data 42D
T1 second image data 41
P pharmaceutical department
NS nurses' station
NCA non-confidential area

What is claimed:

1. A display system, comprising:
a display device configured to hold first image data and second image data and configured to display the first image data or the second image data, the first image data including confidential information, the second image being non-confidential information; and
a remote control including a manipulation component configured to produce signals and send the signals to the display device,
wherein the remote control includes:
a first signal production component configured to produce a first image switching signal in response to the manipulation component being manipulated by a user, the first image switching signal being a command signal to switch between the first image data and the second image data; and
a transmitter configured to transmit the first image switching signal to the display device,
the display device includes:
a receiver configured to receive the first image switching signal from the remote control;
a first image switching component configured to direct switching between the first image data and the second image data according to the first image switching signal; and
a display component configured to display the first image data or the second image data according to a command from the first image switching component, and
the first image switching component is configured to execute first image switching control when the first image switching signal is inputted, the first image switching control including switching the first image data displayed on the display component to the second image data and switching the second image data displayed on the display component to the first image data.

2. The display system according to claim 1,
wherein the display device is prevented from receiving another first image switching signal for a specific length of time after the first image switching component executes the first image switching control.

3. The display system according to claim 1,
wherein the remote control further includes a second signal production component configured to produce a second image switching signal in response to the manipulation component being manipulated by the user, the second image switching signal being a command signal to switch among one or more sets of third image data and image data with no third image data,
the display device is further configured to hold the one or more sets of third image data and configured to receive the second image switching signal through the receiver, the display device further including a second image switching component configured to direct switching among the one or more sets of third image data and the image data with no third image data according to the second image switching signal, and
the display component is configured to display one of the one or more sets of third image data superposed over the first image data according to a command from the second image switching component.

4. The display system according to claim 3,
wherein the one or more sets of third image data includes a plurality of sets of third image data, and
the second image switching component is configured to successively switch among the plurality of sets of third image data and the image data with no third image data to be displayed on the display component every time the second image switching signal is inputted.

5. The display system according to claim 3,
wherein the manipulation component of the remote control includes a first manipulation component and a second manipulation component,
the first signal production component produces the first image switching signal in response to the first manipulation component being manipulated by the user, and
the second signal production component produces the second image switching signal in response to the second manipulation component being manipulated by the user.

6. The display system according to claim 2,
wherein the display device is prevented from receiving another first switching signal for a specific length of time after the first image switching component executes the first image switching control, according to an area where the display device is.

7. The display system according to claim 1,
wherein the display device is configured to identify the remote control on the basis of the correspondence between the first image data held by the display device and the first image switching signal sent from the remote control.

8. The display system according to claim 7,
wherein the remote control includes a plurality of remote controls assigned different identification information.

9. A display device, comprising:
a memory configured to hold first image data including confidential information and second image data that is non-confidential information;
a receiver configured to receive a switching signal to switch between the first image data and the second image data;
a determination component configured to identify the switching signal;
an image switching component configured to direct switching between the first image data and the second image data according to the switching signal; and
a display component configured to display the first image data or the second image data according to a command from the image switching component,
wherein the determination component is prevented from receiving another switching signal for a specific length of time after switching between the first image data and the second image data.

10. A display control method using a display device and a remote control, the display device being configured to hold first image data including confidential information and second image data that is non-confidential information and configured to display the first image data or the second image data, the remote control having a manipulation component configured to produce signals and send the signals to the display device, the display control method including:
producing an image switching signal at the remote control in response to the manipulation component being manipulated by a user, the image switching signal being a command signal to switch between the first image data and the second image data;
transmitting the image switching signal from the remote control to the display device;
switching the first image data displayed on the display component to the second image data or switching the second image data displayed on the display component to the first image data, in response to the image switching signal.

11. A pharmaceutical management system, comprising:
a display device configured to hold first image data and second image data and configured to display the first image data or the second image data, the first image data including confidential information, the second image data being non-confidential information;
a remote control including a manipulation component configured to produce signals and send the signals to the display device; and
at least one conveyance container configured to convey a pharmaceutical dispensed for a patient, each of the at least one conveyance container being attached with the display device,
wherein the remote control includes:
a first signal production component configured to produce a first image switching signal in response to the manipulation component being manipulated by a user, when the at least one conveyance container is in a confidential management area, the first image switching signal being a command signal to switch between the first image data and the second image data; and
a transmitter configured to transmit the first image switching signal to a plurality of the display devices simultaneously,
the display device includes:
a receiver configured to receive the first image switching signal from the remote control;
a first image switching component configured to direct switching between the first image data and the second image data according to the first image switching signal; and
the first image switching component is configured to execute first image switching control when the first image switching signal is inputted, the first image switching control including switching the first image data displayed on the display component to the second image data and switching the second image data displayed on the display component to the first image data.
